(19) United States
(12) Patent Application Publication
(10) Pub. No.: US 2024/0394470 A1
(43) Pub. Date: Nov. 28, 2024

(54) METHOD, APPARATUS, ELECTRONIC DEVICE AND COMPUTER READABLE STORAGE MEDIUM FOR DOCUMENT PROCESSING

(71) Applicant: Beijing Zitiao Network Technology Co., Ltd., Beijing (CN)

(72) Inventors: Haowei SUN, Beijing (CN); Jinpeng WANG, Beijing (CN); Zebin CHEN, Beijing (CN); Wanjun HUANG, Beijing (CN)

(21) Appl. No.: 18/695,192

(22) PCT Filed: Sep. 22, 2022
(86) PCT No.: PCT/CN2022/120505

§ 371 Date: Mar. 25, 2024

(30) Foreign Application Priority Data
Sep. 24, 2021 (CN) 202111124152.9

(51) Int. Cl. G06F 40/186; G06F 40/117

(52) U.S. Cl. CPC G06F 40/186; G06F 40/117

(57) ABSTRACT

The disclosure relates to a method, apparatus, electronic device and computer readable storage medium for document processing, including: in response to receiving a presenting operation for a document content, displaying at least one first document identification at a first predetermined position in a content page of a document; and in response to receiving an editing operation at a second predetermined position in the content page, replacing or hiding the first document identification, based on receiving the presenting operation on the document content, at least one first document identification is displayed at a first predetermined position of the content page of the document and displayed to the user, so that the user can directly select the required document from the displayed first document identification, which facilitates the user to find a suitable document template more quickly, optimizes the user's document usage links, and simplifies the user operations, thereby improving user experience.

### CROSS REFERENCE

This application is based on Chinese Patent Application No. 202111124152.9, filed on Sep. 24, 2021, entitled “Method, Apparatus, Electronic Device and Computer Readable Storage Medium for Document Processing”, and claims priority to the Chinese Patent Application, the entirety of which is incorporated herein by reference.

### FIELD

The present disclosure relates to the field of computers, and more particularly to a method, apparatus, electronic device and computer readable storage medium for document processing.

### BACKGROUND

With the popularity of electronic office products, users will use electronic office products to create various documents in the process of using them.

Currently, before creating a document, users can select the predetermined document content in the product and edit based on the document content. However, these predetermined document contents are difficult to meet the precise needs of users, resulting in low user willingness to use the predetermined document content.

### SUMMARY

To solve the above technical problems, the present disclosure provides a method, apparatus, electronic device and computer readable storage medium for document processing.

In a first aspect, the present disclosure provides a method for document processing, comprising:
in response to receiving a presenting operation for a document content, displaying at least one first document identification at a first predetermined position in a content page of a document; and
in response to receiving an editing operation at a second predetermined position in the content page, replacing or hiding the first document identification.

Optionally, the in response to receiving an editing operation at a second predetermined position in the content page, replacing or hiding the first document identification comprises:
in response to receiving a content input operation in a first content type region at a second predetermined position in the content page, hiding the first document identification.

Optionally, the in response to receiving an editing operation at a second predetermined position in the content page, replacing or hiding the first document identification comprises:
in response to receiving a focus location operation in a first content type region at a second predetermined position in the content page, hiding the first document identification.

Optionally, the in response to receiving an editing operation at a second predetermined position in the content page, replacing or hiding the first document identification comprises:
in response to receiving a content input operation in a second content type region at a second predetermined position in the content page, obtaining an inputted content; and
obtaining a second document identification based on the content and replacing the first document identification with the second document identification.

Optionally, the replacing the first document identification with the second document identification comprises:
hiding the first document identification and displaying the second document identification at a corresponding position of the first document identification.

Optionally, the displaying the second document identification at a corresponding position of the first document identification comprises:
in response to the second document identification being displayed at the corresponding position, moving the second document identification a first predetermined distance along a first direction and then moving the second document identification a second predetermined distance along a second direction.

Optionally, the method further comprising:
in response to receiving a presenting operation on a document content, displaying a first component at the first predetermined position; and
in response to a triggering operation on the first component, hiding a content of the first predetermined position.

Optionally, the method further comprising:
in response to receiving a presenting operation for a document content, displaying a second component at the first predetermined position;
in response to a triggering operation for the second component, displaying a document identification interface, the document identification interface comprising at least one document identification which has an association relationship with the editing operation.

Optionally, the method further comprising:
in response to a triggering operation for the first document identification, obtaining a target document content corresponding to the first document identification, displaying the target document content at a content page of the document, and hiding a content of the first document identification and/or the first predetermined position.

Optionally, the method further comprising:
in response to a triggering operation for the first document identification, displaying a first document page, the first document page comprising a document content corresponding to the first document identification.

Optionally, the method further comprising:
in response to the first document identification being focused on, moving the first document identification a first predetermined distance along a first direction.

Optionally, the obtaining a second document identification based on the content and replacing the first document identification with the second document identification comprises:
if the number of second document identifications obtained based on the content is greater than or equal to a predetermined number, replacing, based on matching degrees, the first document identification with a predetermined number of second document identifications which have the highest matching degrees in the second document identifications.

Optionally, the obtaining a second document identification based on the content and replacing the first document identification with the second document identification comprises:
if the number of second document identifications obtained based on the content is greater than or equal to 1 and less than a predetermined number, replacing the first document identification with the determined second document identification.

Optionally, the obtaining a second document identification based on the content and replacing the first document identification with the second document identification comprises:
if a second document identification is not identified based on the content, displaying prompt information without a second document identification.

Optionally, the in response to a triggering operation for the second component, displaying a document identification interface comprises:
if the number of obtained second document identifications is greater than a predetermined number, in response to a triggering operation for the second component, displaying a document identification interface, the document identification interface comprising at least one second document identification and at least one second document identification;
or,
if the number of obtained second document identifications is less than or equal to a predetermined number, in response to a triggering operation for the second component, displaying a document identification interface, the document identification interface comprising at least one first document identification.

Optionally, the obtaining a second document identification based on the content and replacing the first document identification with the second document identification comprises:
obtaining the second document identification by performing a fuzzy search in a template library based on the content to, and replacing the first document identification with the second document identification.

In a second aspect, embodiments of the present disclosure provide an apparatus for document processing, comprising:
a first document identification displaying module configured to in response to receiving a presenting operation for a document content, display at least one first document identification at a first predetermined position of a content page of a document; and
a first document identification operating module configured to in response to receiving an editing operation at a second predetermined position in the content page, replace or hide the first document identification.

In a third aspect, embodiments of the present disclosure provide an electronic device, comprising:
one or more processors; and
a storage device for storing one or more programs,
the one or more programs, when executed by the one or more processors, causing the one or more processors to implement the method according to any of the first aspects.

In a fourth aspect, embodiments of the present disclosure provide a computer-readable storage medium having a computer program stored thereon, wherein the program, when executed by a processor, implements the method according to any of the first aspects.

The embodiments of the present disclosure provide the following advantages over the Prior Art:

Embodiments of the present disclosure provide a method, apparatus, electronic device and computer readable storage medium for document processing, in response to receiving a presenting operation for a document content, displaying at least one first document identification at a first predetermined position in a content page of a document; and in response to receiving an editing operation at a second predetermined position in the content page, replacing or hiding the first document identification, based on receiving the presenting operation for the document content, at least one first document identification is displayed to the user at a first predetermined position of the document content page, so that the user can directly select the required document template in the first document identification display, in addition, when the user performs the editing operation at a second predetermined position of the content page, the first document identification is replaced or hidden to find the appropriate document template more quickly, the document use link of the user is optimized, the operation of the user is simplified, and the user experience is improved.

### BRIEF DESCRIPTION OF THE DRAWINGS

The accompanying drawings herein, which are incorporated in and constitute a part of this specification, illustrate embodiments conforming to the present disclosure, and together with the specification, serve to explain the principles of the present disclosure.

For clearer description of the technical solutions in the embodiments of the present disclosure or in the prior art, the accompanying drawings needed to be used in the description of the embodiments or the prior art will be briefly introduced below. Apparently, for those of ordinary skill in the art, it is said that other drawings can be obtained from these accompanying drawings without exerting creative labor.

FIG. 1 is a schematic flowchart of a method for document processing provided by the embodiments of the present disclosure;

FIG. 2 is a schematic diagram of a document processing interface provided by the embodiments of the present disclosure;

FIG. 3 is a schematic diagram of another document processing interface provided by the embodiments of the present disclosure;

FIG. 4 is a schematic diagram of further document processing interface provided by the embodiments of the present disclosure;

FIG. 5 is a schematic diagram of further document processing interface provided by the embodiments of the present disclosure;

FIG. 6 is a schematic diagram of further document processing interface provided by the embodiments of the present disclosure;

FIG. 7 is a schematic flowchart of another method for document processing provided by the embodiments of the present disclosure;

FIG. 8 is a schematic flowchart of further method for document processing provided by the embodiments of the present disclosure;

FIG. 9 is a schematic diagram of further document processing interface provided by the embodiments of the present disclosure;

FIG. 10 is a schematic flowchart of further method for document processing provided by the embodiments of the present disclosure;

FIG. 11A is a schematic diagram of further document processing interface provided by the embodiments of the present disclosure;

FIG. 11B is a schematic diagram of further document processing interface provided by the embodiments of the present disclosure;

FIG. 12 is a schematic flowchart of further method for document processing provided by the embodiments of the present disclosure;

FIG. 13A is a schematic diagram of further document processing interface provided by the embodiments of the present disclosure;

FIG. 13B is a schematic diagram of further document processing interface provided by the embodiments of the present disclosure;

FIG. 14 is a schematic flowchart of further method for document processing provided by the embodiments of the present disclosure;

FIG. 15A is a schematic diagram of further document processing interface provided by the embodiments of the present disclosure;

FIG. 15B is a schematic diagram of further document processing interface provided by the embodiments of the present disclosure;

FIG. 15C is a schematic diagram of further document processing interface provided by the embodiments of the present disclosure;

FIG. 16A is a schematic diagram of further document processing interface provided by the embodiments of the present disclosure;

FIG. 16B is a schematic diagram of further document processing interface provided by the embodiments of the present disclosure;

FIG. 17A is a schematic diagram of further document processing interface provided by the embodiments of the present disclosure;

FIG. 17B is a schematic diagram of further document processing interface provided by the embodiments of the present disclosure;

FIG. 18 is a schematic diagram of further document processing interface provided by the embodiments of the present disclosure;

FIG. 19 is a schematic flowchart of further method for document processing provided by the embodiments of the present disclosure;

FIG. 20 is a schematic flowchart of further method for document processing provided by the embodiments of the present disclosure;

FIG. 21 is a schematic diagram of further document processing interface provided by the embodiments of the present disclosure;

FIG. 22 is a schematic flowchart of further method for document processing provided by the embodiments of the present disclosure;

FIG. 23 is a schematic diagram of further document processing interface provided by the embodiments of the present disclosure;

FIGS. 24A-24E are schematic diagrams of further document processing interface provided by the embodiments of the present disclosure;

FIG. 25A is a schematic diagram of further document processing interface provided by the embodiments of the present disclosure;

FIG. 25B is a schematic diagram of further document processing interface provided by the embodiments of the present disclosure;

FIG. 26A is a schematic diagram of further document processing interface provided by the embodiments of the present disclosure;

FIG. 26B is a schematic diagram of further document processing interface provided by the embodiments of the present disclosure;

FIG. 27 is a schematic structural diagram of an apparatus for document processing provided by the embodiments of the present disclosure; and

FIG. 28 is a schematic structural diagram of an electronic device provided by the embodiments of the present disclosure.

### DETAILED DESCRIPTION

To understand the above objects, features and advantages of the present disclosure more clearly, the following solutions of the present disclosure will be further described. It should be noted that, without conflict, the embodiments of the present disclosure and features in the embodiments may be combined with each other.

Many specific details are set forth in the following description in order to fully understand the present disclosure, but the present disclosure may also be implemented in other ways different from that described herein. Apparently, the embodiments in the specification are only part of the embodiments of the present disclosure, not all embodiments.

Exemplarily, the present disclosure provides a method, apparatus, electronic device and storage media for document processing. In a usage scenario of a content page of a document, when a document title is input into the content page of the document, a second document identification is determined based on an input document title, and the second document identification is displayed on the content page of the document, thereby improving the convenience of using the template by the user and improving the experience of using the template by the user.

Wherein the method for document processing disclosed herein is performed by an electronic device or an application program, a web page, an official account, etc. in an electronic device. the electronic device may be a tablet computer, a mobile phone, a wearable device, a vehicle, an augmented reality (AR)/virtual reality (VR), a notebook computer, an ultra-mobile personal computer (UMPC), a netbook, a personal digital assistant (PDA), a smart TV, a smart screen, a high definition TV, a 4K TV, a smart speaker, a smart projector, etc. and the present disclosure does not limit the specific type of the electronic device.

Wherein the type of operating system of the electronic device is not limited in the present disclosure. For example, an Android system, a Linux system, a Windows system, an iOS system, etc.

The technical solutions of the present disclosure will be described in detail below with several specific embodiments.

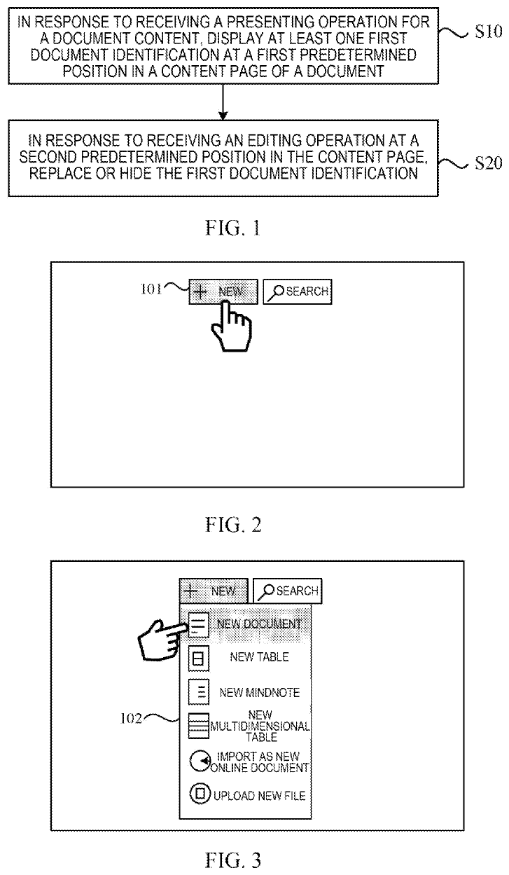

FIG. 1 is a schematic flowchart of a method for document processing provided by the embodiments of the present disclosure, as shown in FIG. 1, the method of the present embodiment is as follows:

S10, in response to receiving a presenting operation for a document content, displaying at least one first document identification at a first predetermined position in a content page of a document.

Specifically, the document includes a plurality of types such as text, table, PPT (PowerPoint, presentation file), PDF (Portable Document Format), collection table, MindNotes, and mind maps, etc. The user can view and modify document at any time on a plurality of types of devices such as a computer, mobile terminal, or notebook computer, or can also view or modify documents by means of a webpage, wherein at the computer terminal, the document can be viewed and modified by means of a personal computer client or online document webpage version, and at the mobile terminal, the document can be viewed and modified by means of an online document application program or online document applet.

Presenting operation includes new or opening documents.

As shown in FIG. 2, when the user clicks the “New” button 101, a menu interface 102 of a new document is displayed in the document. As shown in FIG. 3, the menu interface 102 includes a new document, a new table, a new MindNotes, a new multi-dimensional table, importing it as a new online document, uploading a new file, etc.

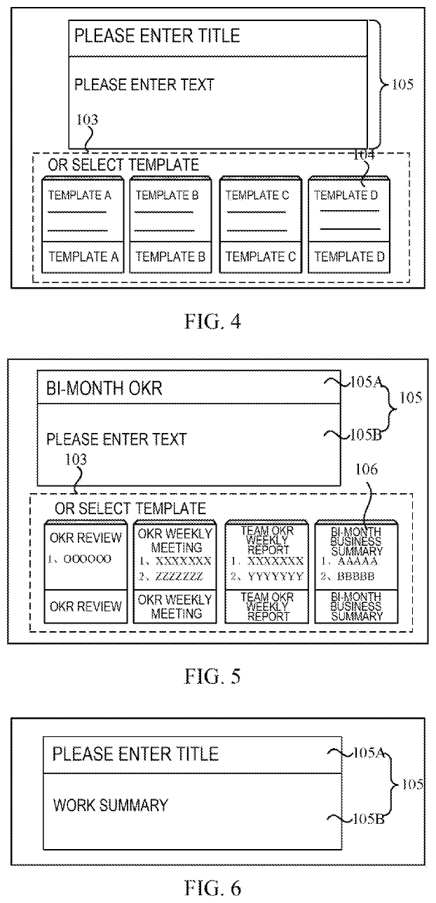

When the user clicks the new document icon in the menu interface 102, the document jumps to the content page of the new document, as shown in FIG. 4, the content page of the new document includes at least one first document identification 104 displayed at a first predetermined position 103.

It should be noted that FIG. 4 illustrates that the first predetermined position 103 in the content page of the document is located at the bottom of the document, and in other embodiments, the first predetermined position 103 may be the top of the document, or the left side of the document or the right side of the document, and embodiments of the present disclosure do not specifically limit the first predetermined position 103 in the content page of the document.

S20, in response to receiving an editing operation at a second predetermined position in the content page, replacing or hiding the first document identification.

When receiving the presenting operation for the document content, while at least one first document identification 104 is displayed at the first predetermined position 103 of the content page of the document, the document content page further includes a second predetermined position 105. Specifically, the second predetermined position 105 includes a document title or document body. When the user performs editing operation at the second predetermined position 105 of the document content page, the first document identification 104 is replaced or hidden. Exemplarily, when the second predetermined position 105 of the content page of the document is the document title 105A, the user replaces the first document identification 104 after performing the editing operation at the position of the document title 105A of the content page of the document, as shown in FIG. 5, when the second predetermined position 105 of the content page of the document is the document body 105 B, the user hides the first document identification 104 after performing the editing operation at the position of the document body 105 B of the document content page of the document, as shown in FIG. 6.

It should be noted that, in addition, FIG. 4 exemplarily shows that the number of first document identification 104 displayed on the content page of the document is 4, in other embodiments, the number of first document identification 104 displayed on the content page of the document may also be 1, 2, 3, or even more, those skilled in the art can adjust the number of first document identification 104 displayed on the content page of the document according to the size of the content page of the document adaptively, for example, when document title is inputted in the document title of the online document web version of the personal computer client, the number of first document identification 104 displayed on the content page of the document is 4. When the document title is inputted in the online document application on the mobile terminal or when the document title is inputted in the document title is inputted in the document title of the online document applet, the number of first document identification 104 displayed on the content page of the document is 2.

Embodiments of the present disclosure provide a method for document processing, in response to receiving a presenting operation for a document content, displaying at least one first document identification at a first predetermined position in a content page of a document; and in response to receiving an editing operation at a second predetermined position in the content page, replacing or hiding the first document identification, based on receiving the presenting operation for the document content, at least one first document identification is displayed to the user at a first predetermined position of the document content page, so that the user can directly select the required document template in the first document identification display, in addition, when the user performs the editing operation at a second predetermined position of the content page, the first document identification is replaced or hidden to find the appropriate document template more quickly, the document use link of the user is optimized, the operation of the user is simplified, and the user experience is improved.

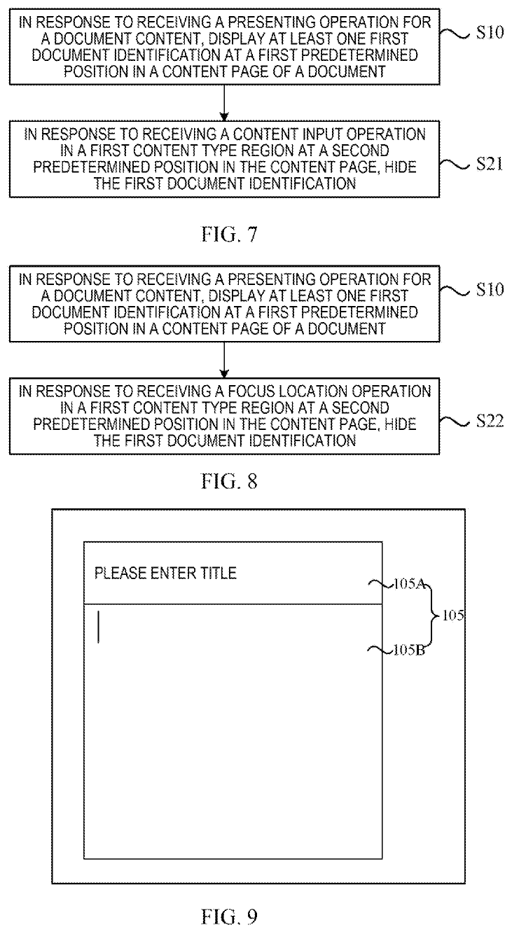

FIG. 7 is a schematic flowchart of another method for document processing provided by the embodiments of the present disclosure, embodiments of the present disclosure is based on the above embodiment, as shown in FIG. 7, an implementation method of step S20 includes:

S21, in response to receiving a content input operation in a first content type region at a second predetermined position in the content page, hiding the first document identification.

When the user inputs content at the first content type region 105B at the second predetermined position 105 of the content page of the document, the first document identification 104 at the first predetermined position 103 of the content page of the document is hidden. Exemplarily, in conjunction with FIGS. 4 and 6, after the user inputs “work summary” at the position of “please enter text” on the content page of the document, the first document identification 104 is not displayed at the first predetermined position 103, i.e., the first document identification 104 is hidden.

FIG. 8 is a schematic flowchart of further method for document processing provided by the embodiments of the present disclosure, embodiments of the present disclosure is based on the above embodiment, as shown in FIG. 8, and another implementation method of step S20 includes:

S22, in response to receiving a focus location operation in a first content type region at a second predetermined position in the content page, hiding the first document identification.

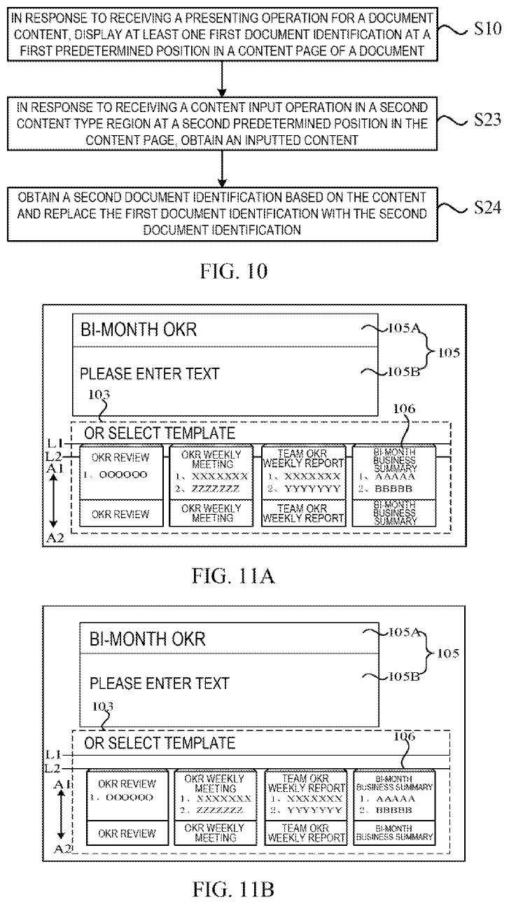

When the user positions the focus to the first content type region 105B at the second predetermined position 105 of the content page of the document, the first document identification 104 at the first predetermined position 103 of the content page of the document is hidden. Exemplarily, in conjunction with FIGS. 4 and 9, after the user positions the focus to the position of “Please enter text” on the content page of the document, the first document identification 104 is not displayed at the first predetermined position 103, i.e., the first document identification 104 is hidden.

FIG. 10 is a schematic flowchart of further method for document processing provided by the embodiments of the present disclosure, embodiments of the present disclosure is based on the above embodiment, as shown in FIG. 10, and another implementation method of step S20 includes:

S23, in response to receiving a content input operation in a second content type region at a second predetermined position in the content page, obtaining an inputted content.

When the user inputs content at the second content type region 105A of the second predetermined position 105 of the content page of the document, the content inputted by the user at the second content type region 105A of the second predetermined position 105 of the content page of the document is obtained. Exemplarily, as shown in FIG. 5, after the user inputs “bi-month OKR” at the position of “Please enter title” on the content page of the document, the content “bi-month OKR” inputted by the user at the position of “Please enter title” on the content page of the document is obtained.

S24, obtaining a second document identification based on the content and replacing the first document identification with the second document identification.

Optionally, obtaining a second document identification based on the content and replacing the first document identification with the second document identification, including:

The second document identification is obtained based on the content and the first document identification is hided, and the second document identification at the corresponding position of the first identification is displayed.

When the user inputs content at the second content type region 105A of the second predetermined position 105 of the content page of the document, the second document identification 106 based on the content is obtained. The specific process of replacing the first document identification 104 with the second document identification 106 is: after the user inputs the content in the second content type region 105A at the second predetermined position 105 of the content page, in response to the operation of the user inputting the content in the text box of the second content type region 105A, the content is obtained from the text box of the second content type region 105A, and then a fuzzy search is performed in the document identification library according to the content, the second document identification 106 is obtained, the first document identification 104 is hided, and the first document identification 104 is replaced with the second document identification 106.

Exemplarily, in conjunction with FIGS. 4 and 5, when the user inputs “bi-month OKR” in the text box of the second content type region, the second document identification obtained from the “bi-month OKR” inputted in the text box of the second content type region includes “OKR review”. “OKR weekly meeting”. “team OKR weekly report”, and “bi-month business summary”, etc. At this time, the first document identification 104 is hidden, and the second document identification 106 is used to replace the first document identification 104.

Optionally, in response to the second document identification being displayed at the corresponding position, moving the second document identification a first predetermined distance along a first direction and then moving the second document identification a second predetermined distance along a second direction.

Exemplarily, in combination with FIGS. 11A and 11B, when the user inputs “bi-month OKR” in the text box of the second content type region 105A, the second document identification 106 obtained based on the “bi-month OKR” inputted in the text box of the second content type region 105A includes “OKR review”, “OKR weekly meeting”, “team OKR weekly report” and “bi-month business summary”, etc. At this time, in response to the second document identification 106 being displayed at the corresponding position, the second document identification 106 moves a first predetermined distance along the first direction A1 and moves a second predetermined distance along the second direction A2. Specifically, the second document identification 106 is moved a first predetermined distance along the first A1 to arrive at a position corresponding to the first reference line L1, and then moved a second predetermined distance along the second direction A2 to arrive at a position corresponding to the second reference line L2.

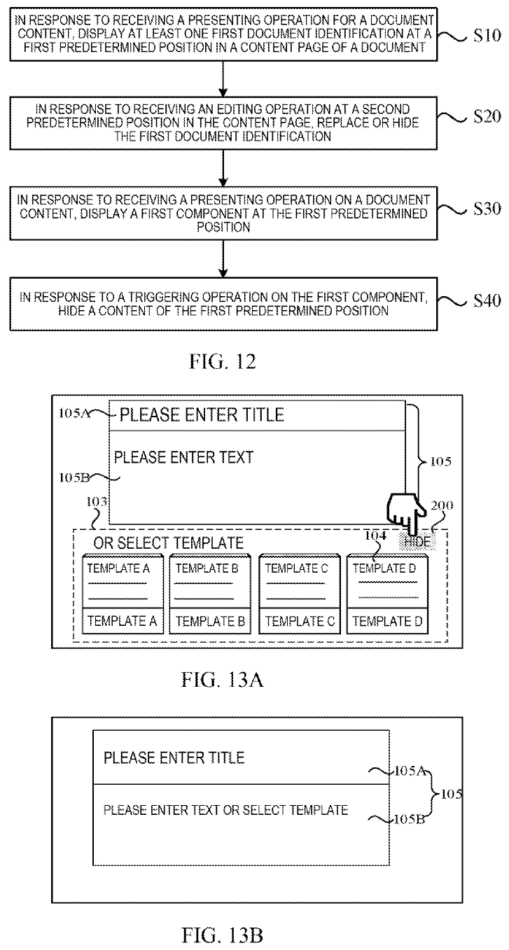

FIG. 12 is a schematic flowchart of further method for document processing provided by the embodiments of the present disclosure, embodiments of the present disclosure is based on the above embodiment, shown in FIG. 12, the method further including:

S30, in response to receiving a presenting operation on a document content, displaying a first component at the first predetermined position.

Exemplarily, as shown in FIG. 13A, the first component 200 is displayed at a first predetermined position when the presenting operation on the document content is received.

It is to be noted that FIG. 13A exemplarily represents a schematic structural diagram of a first component 200, embodiments of the present disclosure do not specifically limit the shape, position, color of the first component.

S40, in response to a triggering operation on the first component, hiding a content of the first predetermined position.

When the user triggers the first component 200, the content of the first predetermined position 103 is hidden, in conjunction with FIGS. 13A and 13B, when the user triggers the first component 200 displayed in FIG. 13A, the content of the first predetermined position 103 is hidden, as shown in FIG. 13B.

It should be noted that when the user triggers the first component 200 to hide the content of the first predetermined position 103, “Please enter text, or select template” is displayed in the first content area 105B of the second predetermined position 105, and the user triggers “or select template”, at least one first document identification 104 is displayed at the first predetermined position 103 of the document content, and at this time, “Please enter text” is displayed at the first content area 105B of the second predetermined position 105, i.e., FIG. 13A.

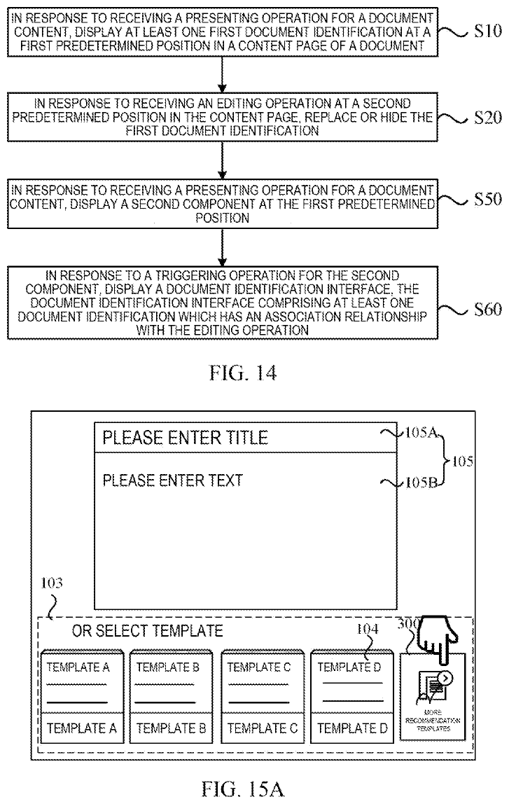

FIG. 14 is a schematic flowchart of further method for document processing provided by the embodiments of the present disclosure, embodiments of the present disclosure is based on the above embodiment, as shown in FIG. 14, the method further including:

S50, in response to receiving a presenting operation for a document content, displaying a second component at the first predetermined position.

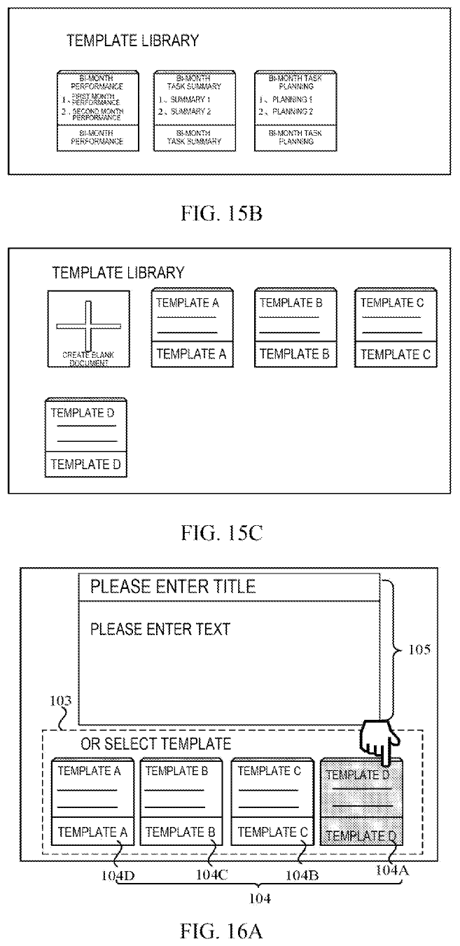

Exemplarily, as shown in FIG. 15A, the second document 300 is displayed at a first predetermined position 103 when the presenting operation of the document content is received.

It should be noted that FIG. 15A exemplarily represents a schematic structural diagram of a second document 300, embodiments of the present disclosure do not specifically limit the shape, position, color of the second document 300.

S60, in response to a triggering operation for the second component, displaying a document identification interface.

Wherein the document identification interface comprising at least one document identification which has an association relationship with the editing operation.

The document identification interface is displayed when the user triggers the second document 300, and the document identification interface is displayed when the user triggers the second document 300 displayed at first predetermined position 103 in FIG. 15A, the document identification interface comprises at least one document identification, and the document identification having an association relationship with the editing operation. Exemplary, when the editing operation of the user on the second predetermined position 105 of the content page is to perform an editing operation at the document title 105A position of the document content page of the document, after the user triggers the second document 300, the document identification related to the document title inputted by the user at the document title 105A position is displayed at the document identification interface, as shown in FIG. 15C. when the editing operation of the user on the second predetermined position 105 of the content page is to perform at the editing operation at the document body 105 B position of the content page of the document, after the user triggers the second document 300, the document identification interface in the document identification library is displayed on the display document identification interface, as shown in FIG. 15C.

Optionally, the method further includes:
in response to a triggering operation for the first document identification, obtaining a target document content corresponding to the first document identification, displaying the target document content at a content page of the document, and hiding a content of the first document identification and/or the first predetermined position.

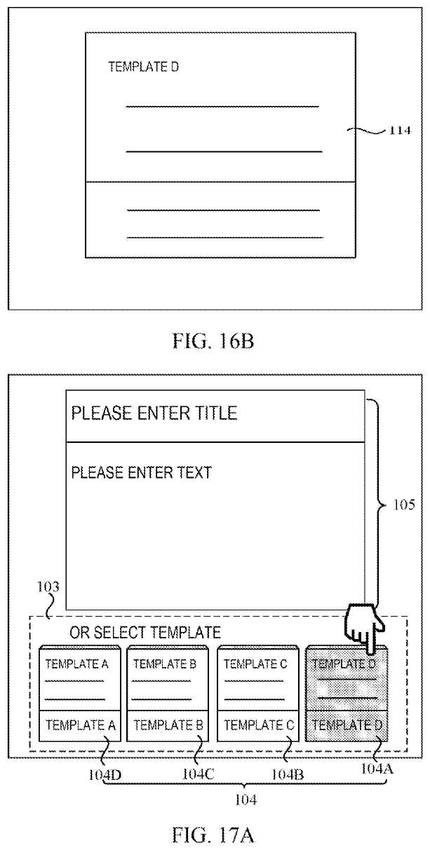

Exemplarily, as shown in FIG. 16A, when the user triggers the first document identification 104A, at this time, the target document content corresponding to the first document identification 104A triggered by the user, and the target document content 114 is displayed on the content page of the document, as shown in FIG. 16B.

Optionally, the method further includes:
in response to a triggering operation for the first document identification, displaying a first document page, the first document page comprising a document content corresponding to the first document identification.

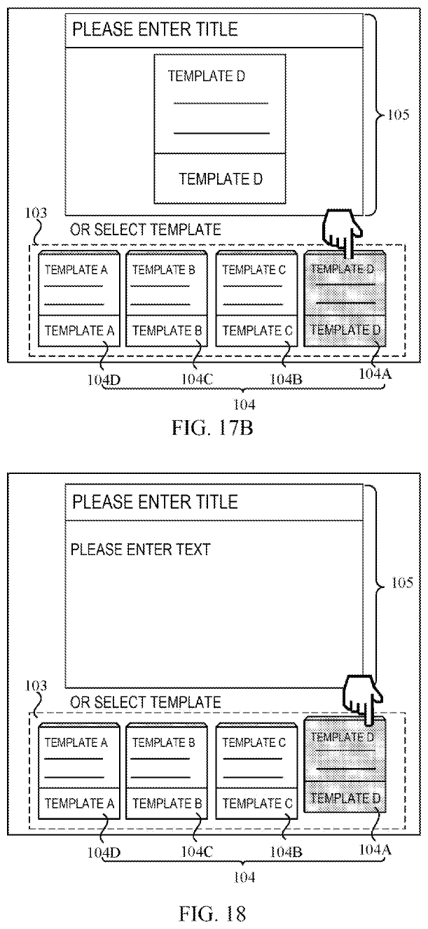

Exemplarily, as shown in FIG. 17A, when the user triggers the first document identification 104A, at this time, the first document page 114 is displayed based on the first document identification 104A triggered by the user, as shown in FIG. 17B, i.e., after the first document identification is triggered by the user, the content of the document corresponding to the first document identification is displayed through the preview screen.

Optionally, the method further includes:
in response to the first document identification being focused on, moving the first document identification a first predetermined distance along a first direction.

Exemplary, as shown in FIG. 18, after the user locates the focus on first document identification 104A, the first document identification is moved a first predetermined distance along the first direction, realizing that the first document identification 104A is prominently displayed in comparison to other first document identification.

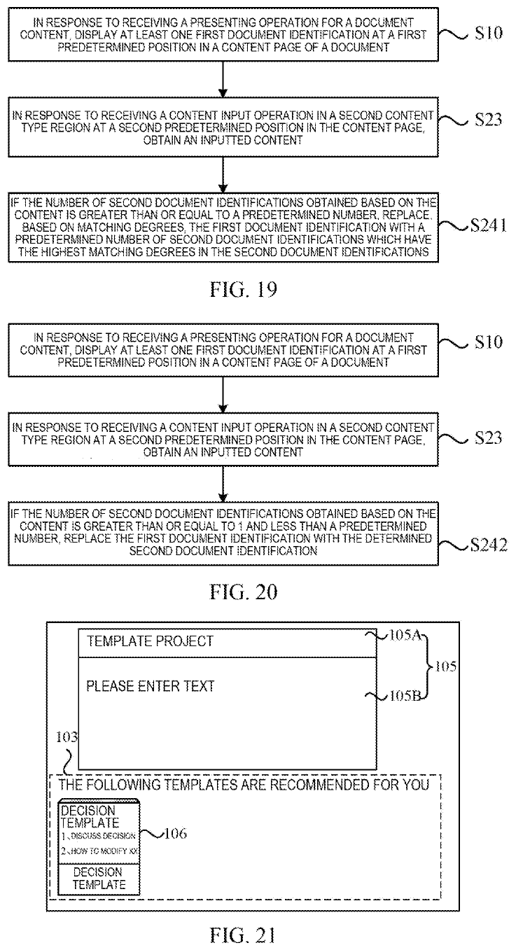

FIG. 19 is a schematic flowchart of further method for document processing provided by the embodiments of the present disclosure, embodiments of the present disclosure is based on the corresponding embodiment of FIG. 10, as shown in FIG. 19, one implementation of step S24 includes:

S241, if the number of second document identifications obtained based on the content is greater than or equal to a predetermined number, replacing, based on matching degrees, the first document identification with a predetermined number of second document identifications which have the highest matching degrees in the second document identifications.

When the user inputs content in the second predetermined position on the second content type region of the content page, the specific process of obtaining second document identification based on the content is: after the user inputs content in the text box corresponding to the second content type region, in response to the operation of the user inputting the content in the text box corresponding to the second content type region, the content is obtained from the text box corresponding to the second content type region, and then a fuzzy search is performed in the document identification library based on the content to determine the matching second document identification. If the number of second document identifications obtained based on the content is greater than or equal to a predetermined number, replacing, based on matching degrees, the first document identification with a predetermined number of second document identifications which have the highest matching degrees in the second document identifications.

Exemplarily, if the number of second document identifications displayed on the content page of the document is 4, when the user inputs “bi-month OKR” in the text box corresponding to the second predetermined position, the document identification obtained based on the content of “bi-month OKR” include “OKR review”, “OKR weekly meeting”, “team OKR weekly report”, “bi-month business summary”, “bi-month performance”, “bi-month task summary”, and “bi-month task planning”. At this time, the second document identification displayed on the content page of the document is “OKR review”, “OKR weekly meeting”. “team OKR weekly report”, “bi-month business summary”, which replaces “template 1”, “template 2”, “template 3”, and “template 4” with “OKR review”, “OKR weekly meeting”, “team OKR weekly report”, and “bi-month business summary”, as shown in FIG. 5, i.e., the top 4 document identification with the highest matching degrees on the content page of the document is displayed.

The specific process of replacing the first document identification with a predetermined number of second document identifications which have the highest matching degrees in the second document identifications based on matching degrees, after the user inputs the content in the text box corresponding to the second predetermined position, based on the matching degree between the name of the document identification in the document identification library and the name of the content input by the user in the text box corresponding to the second predetermined position, a predetermined number of second document identification with the highest matching degree are selected. For example, if the content inputted by the user in the text box corresponding to the second predetermined position is “bi-month OKR”, the content can be split into two candidate participles: bi-month and OKR. By analyzing the content, it is determined that the document identification of user requirements is related to OKR. Then, OKR is first selected as the target candidate participle. By comparing the target candidate participle with each document identification in the document identification library, the document identification including OKR is obtained. If the number of document identifications containing OKR candidate participles obtained is less than the predetermined number. For example, if the number of document identification that include OKR is less than the predetermined number, and the number of document identification that include OKR is 3, which are “OKR review”, “OKR weekly meeting” and “team OKR weekly report”. Then, continue to select bi-month as the target candidate segmentation. By comparing the target candidate segmentation with various document identifications in the document identification library to obtain the document identification that include bi-month. If the document identification that include bi-month, and if the document identification that include bi-month is obtained, the document identification that include bi-month is selected. If the number of document identification including bi-month is 4, namely “bi-month business summary”, “bi-month performance”, “bi-month task summary”, and “bi-month task planning”. At this time, the number of document identifications determined based on the content is 7, namely “OKR Review”, “OKR Weekly Meeting”, “team OKR weekly report”, “bi-month business summary”, “bi-month performance”, “bi-month task summary”, and “bi-month task planning”. Since the number of determined document identifications is greater than the number of second document identification set by the user to be displayed on the content page of the document, the first document identification is selected as OKR. In this case, the document identification determined with OKR as the target candidate participle is selected first, i.e., the document identification determined with OKR as the target candidate participle has a higher match, and the number of second document identifications determined is 3, and one document identification determined with bi-month as the target candidate participle is selected. Exemplarily, the document identifications determined with bi-month as the target candidate participle is 4, which are: “bi-month business summary” “bi-month performance”, “bi-month task summary”, and “bi-month task planning”. According to the order of the determined document identifications to select the first document identification “bi-month business summary” for the second document identification. At this time, according to the matching degree to show the highest degree of match before the predetermined number of the second document identifications are: “OKR review”, “OKR weekly meeting”, “team OKR weekly report”, and “Bi-month business summary”.

Embodiments of the present disclosure provide a method for document processing, if the number of second document identifications obtained based on the content is greater than or equal to a predetermined number, replacing, based on matching degrees, the first document identification with a predetermined number of second document identifications which have the highest matching degrees in the second document identifications. Based on the input content to determine the second document identification and display the highest matching degrees before a predetermined number of second document identification to the user in the content page of the document, so that the user can directly in the display of the second document identification document identification to select the required document identification, since the display of the second document identification degree of matching degree and the content of the matching degree of the second document identification to help the user more quickly find the appropriate document identification, to optimize the user's document using the link, simplifies the user's operation, thereby improving the user experience.

FIG. 20 is a schematic flowchart of further method for document processing provided by the embodiments of the present disclosure, embodiments of the present disclosure is based on the corresponding embodiment of FIG. 10, as shown in FIG. 20, another step S24 may be implemented including:

S242, if the number of second document identifications obtained based on the content is greater than or equal to 1 and less than a predetermined number, replacing the first document identification with the determined second document identification.

When the user inputs content in the second predetermined position at the second content type region of the content page, the specific process of obtaining second document identification based on the content is: after the user inputs content in the text box corresponding to the second content type region, in response to the operation of the user inputting the content in the text box corresponding to the second content type region, the content of the document title is obtained from the text box corresponding to the second content type region, and then the fuzzy search is performed in the document identification library based on the content to determine the matching second document identification, if the content is determined according to the second document identification the number of greater than or equal to 1 and less than a predetermined number of, the determined second document identification is used to replace the first document identification.

Exemplarily, if the number of the second document identification displayed on the content page of the document is 4, when the user inputs the “template project” in the text box corresponding to the second predetermined position, the document identification determined according to the content “template project” includes a “decision template”. At this time, the second document identification displayed on the content page of the document according to the content is a “decision template”, as shown in FIG. 21, i.e., the determined second document identification “decision template” is used to replace the first document identification.

According to the content to determine the number of second document identification is greater than or equal to 1 and less than a predetermined number, the specific process of using the determined second document identification to replace the first document identification is that, after the user inputs the content in the text box corresponding to the second predetermined position, according to the content to determine the number of the second document identification is greater than or equal to 1 and less than a predetermined number, the determined second document identification is displayed. For example, if the user inputs “template project” in the text box corresponding to the second predetermined position, the content can be split into two candidate participles: template and project. By analyzing the content, it is determined that the document requested by the user is related to the project. And then, the project is selected as the target candidate participle. By comparing the target candidate participle with each document identification in the document identification library, the document identification including the project is obtained. If the number of document identifications including the project candidate participle is 0, then continue to select the template as the target candidate participle. By comparing the target candidate participle with respective document identification in the document identification library, obtain the document identification including the template. If the number of document identifications including the template is 1, it is a “decision template”. At this time, the number of document identifications determined based on the content is 1, which is a “decision template”. Since the number of the determined second document identification is greater than or equal to 1 and less than the predetermined number, the determined second document identification is directly displayed document identification, the second document identification displayed is: “decision template”.

Embodiments of the present disclosure provide a method for document processing, if the number of second document identification determined based on the document title is greater than or equal to 1 and less than a predetermined number, the determined second document identification is displayed, the second document identification is determined based on the input content and the determined second document identification is displayed to the user in the content page of the document, so that the user can directly select the required document identification in the display of the second document identification, which helps the user to find the appropriate document identification more quickly, optimizes the user's document using the link, simplifies the user's operation, thereby enhancing the user experience.

FIG. 22 is a schematic flowchart of further method for document processing provided by the embodiments of the present disclosure, embodiments of the present disclosure is based on the corresponding to embodiments of FIG. 10, as shown in FIG. 22, another step S24 may be implemented including:

S243, if a second document identification is not identified based on the content, displaying prompt information without a second document identification.

When the user inputs content in the second content region at the second predetermined position of the content page, the specific process of determining the second document identification based on the obtained input content is: after the user inputs content in the text box corresponding to the second content type region, in response to the operation of the user inputting the content in the text box corresponding to the second content type region, the content obtained from the text box corresponding to the second content type region, and then a fuzzy search is performed in the document identification library based on the content to determine the matching second document identification, if a second document identification is not identified based on the content, displaying prompt information without a second document identification.

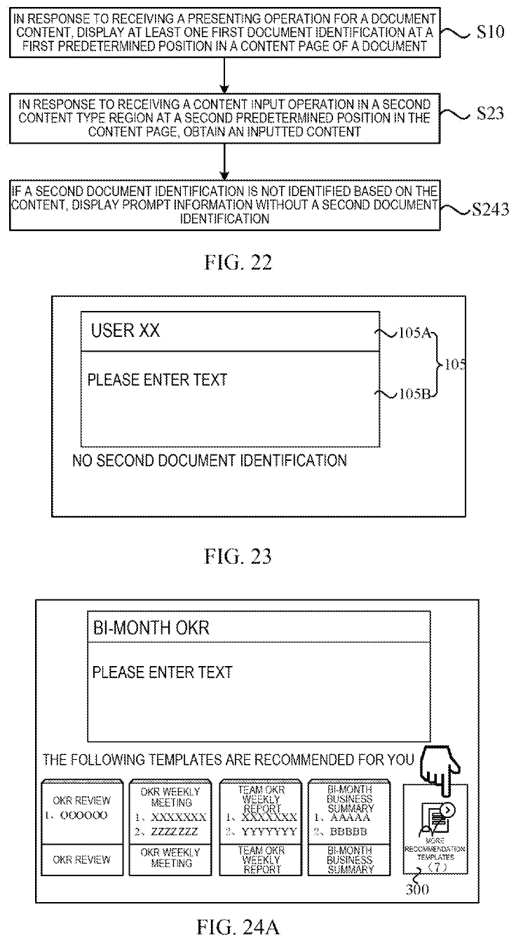

Exemplarily, if the number of the second document identification displayed on the content page of the document is 4, when the user inputs “user XX” in the text box corresponding to the second content region. According to the document title “user XX” to determine that there is no second document identification, at this time, no second document identification prompt information is displayed, as shown in FIG. 23, i.e., no second document identification prompt information is displayed on the content page of the document.

It should be noted that when no second document identification is determined based on the content, the prompt information of no second document identification is displayed at the position of the corresponding title bar of the second document identification, and in other embodiments, when no second document identification is determined based on the document title, the prompt information box is directly popped up to indicate that there is no second document identification. Embodiments of the present disclosure do not qualify the specify prompting method of no second document identification, and furthermore, no second document identification prompt information font size, color, shape, etc., embodiments of the present disclosure is not particularly limited thereto.

Embodiments of the present disclosure provide a method for document processing, if no second document identification is determined based on the content, then the prompt information of no second document identification is displayed. And if no second document identification is determined based on the input content, the prompt information of no second document identification is displayed directly on the content page of the document, so that the user can directly obtain the second document identification corresponding to the current content in the document identification library, avoiding the user to find the second document identification corresponding to the current content in the document identification library, thereby affecting the user experience.

Optionally, if the number of obtained second document identifications is greater than a predetermined number, in response to a triggering operation for the second component, displaying a document identification interface, the document identification interface comprising at least one second document identification and at least one second document identification; if the number of obtained second document identifications is less than or equal to a predetermined number, in response to a triggering operation for the second component, displaying a document identification interface, the document identification interface comprising at least one first document identification.

Exemplary, if the number of obtained second document identifications is greater than a predetermined number, then the title of the second document is “more recommendation templates (the number of determined second document identification)”, if the number of the determined second document identification is less than or equal to the predetermined number, then the title of the second document is “more templates”.

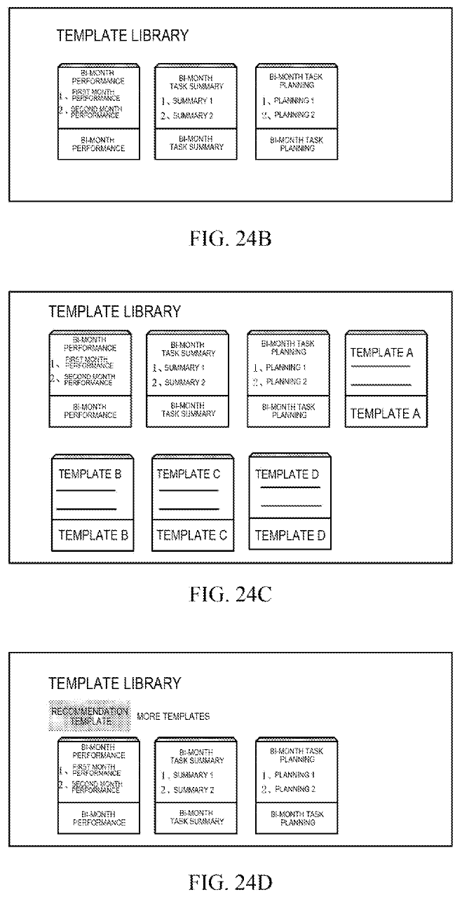

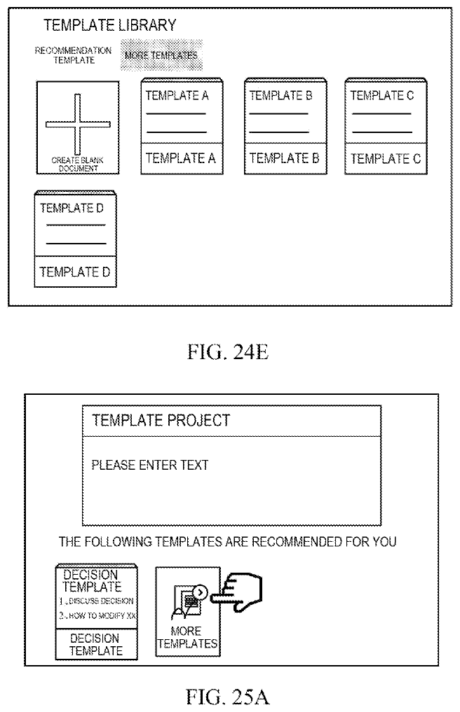

As an implementation method, if the number of second document identifications displayed on the content page of the document is 4, after the user inputs “bi-month OKR” in the text box corresponding to the second predetermined position, the document identifications determined based on the content of “bi-month OKR” include “OKR review”, “OKR weekly meeting”, “team OKR weekly report”, “bi-month business summary”, “bi-month performance”, “bi-month task summary” and “bi-month task planning”, etc., according to the content, the second document identification displayed on the content page of the document are “OKR review”, “OKR weekly meeting”, “team OKR weekly report”, “bi-month business summary”, and the title of the second document is “More recommendation templates (7)”, as shown in FIG. 24A. If the user triggers more recommendation templates (7) in FIG. 24A, in response to the second document is triggered, the document identification interface is displayed as “bi-month performance”, “bi-month task summary”, and “bi-month task planning”, as shown in FIG. 24B.

It is noted that FIG. 24B exemplarily represents that in the event that the user triggers the more recommendation templates (7) in FIG. 24A, in response to the triggering of the second document 300, the remaining templates are displayed as the second document identification determined based on the content input by the user in the text box corresponding to the second predetermined position, except for other second document identification displayed on the content page of the document. Exemplary, FIG. 24C is one implementation, and FIG. 24D is another implementation, in which except for the second document identification displayed on the content page of the document and the document identification recommended by the document identification library are displayed on one interface, and the document identification recommended by the document identification library displayed after the second document identification, except for the second document identification displayed on the content page of the document. In FIGS. 24D and 24E, except for the second document identification displayed on the content page of the document, the document identification recommended by the document identification library is displayed on one interface, and the second document identification displayed on the content page of the document is displayed by triggering the recommendation template, as shown in FIG. 24D, the document identification recommended by the document identification library is displayed by triggering more templates, as shown in FIG. 24E.

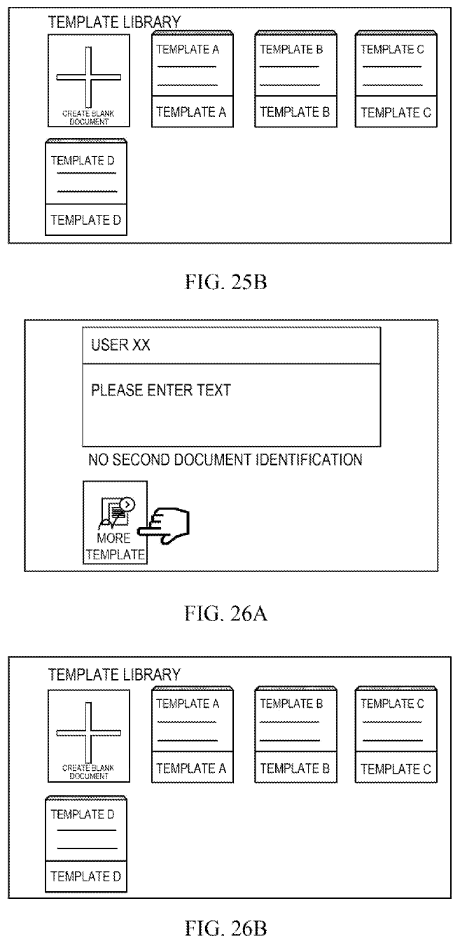

As another implementation, if the number of the second document identification displayed on the content page of the document is 4, when the user inputs “template project” in the text box corresponding to the second predetermined position, the document identification determined based on the content “template project” includes “decision template”, and the second document identification displayed on the content page of the document is “decision template”. At this time, the title of the second document is “more templates”, as shown in FIG. 25A. If the user triggers more templates in FIG. 25A, in response to triggering the second document, the document identification interface is displayed as the document identification in the document identification library. Exemplary second document identification is “work weekly report”, “work daily”. “mind XX” and “meeting record”, as shown in FIG. 25B.

As another further implementation method, when the user inputs “user XX” in the text box corresponding to the second predetermined position, and it is determined that there is no second document identification based on the content “user XX”, the prompt information of no second document identification is displayed. At this time, the title of the second document is “more templates”, as shown in FIG. 26A. If the user triggers the more templates in FIG. 26A, in response to the triggering of the second document, the document identification interface is displayed as the document identification in the document identification library. An exemplary document identification is “work weekly report”, “work daily”, “mind XX”, and “meeting record”, as shown in FIG. 25B.

it should be noted that the above embodiment exemplify the display of an expansion button on the right side of the text box corresponding to the second document identification. In other embodiments, represents a second document identification corresponding to the right side of the text box display expansion button, in other embodiments, exemplary, when the second document identification is displayed on the right side of the content page of the document, an expansion button is displayed below the text box corresponding to the second document identification. Embodiments of the present disclosure do not limit the specific position of the expansion button. In addition, the shape and size of the expansion button and the font size, shape, and color of the title of the expansion button are limited.

In the above embodiments, if the number of second document identification determined based on the document title is greater than or equal to 1, the document template corresponding to the document title displays the prompt information “the following templates recommend for you” prompt information, if the document title determines that there is no second document identification, the document template corresponding to the document title position displays “no second document identification” prompt information.

In the above embodiments, it is exemplary to determine the second document identification based on the inputted content after inputting the content in the text box corresponding to the second predetermined position. In a specific implementation, when the user dynamically inputs the content, for example, the user wishes to input “bi-month OKR”, during the dynamic input process, the user first inputs “bi-month”. At this time, the second document identification has been determined based on the input “bi-month” and displayed on the content page of the document. When the user inputs “bi-month” and continues to input “OKR”, the text input in the second predetermined position is “bi-month OKR”. At this time, the second document identification is determined based on “bi-month OKR” and displayed on the content page of the document. In addition, the dynamic input process further includes the user revoking the input content after the input is completed. For example, after the user inputs the “bi-month OKR”, the second document identification corresponding to the content of “bi-month OKR” is displayed on the content page of the document. When the user revokes the OKR, the second document identification corresponding to the content of “bi-month” is displayed on the content page of the document.

Optionally, the obtaining a second document identification based on the content and replacing the first document identification with the second document identification comprises:
obtaining the second document identification by performing a fuzzy search in a template library based on the content to, and replacing the first document identification with the second document identification.

The specific process of determining the second document identification based on the content is to perform a fuzzy search in the document identification library based on the content to determine the second document identification. The specific fuzzy search process is as follows: at least one candidate word segmentation is obtained by performing word segmentation on the content, and then from the at least one candidate word segmentation is selected as the target candidate word segmentation.

Exemplarily, the content is “bi-month OKR”, and the content is segmented to obtain candidate segmentation including bi-month and OKR. By analyzing the content and determining that the second document identification of the user request is related to OKR, OKR is first selected as the target candidate segmentation. By comparing the target candidate segmentation with the document identifications of respective document template in the document identification library, document identifications matching OKR are obtained. If the number of document identifications obtaining OKR candidate segmentation is less than the predetermined number, bi-month is continued to be selected as the target candidate segmentation. By comparing the candidate segmentation with each document identification in the document identification library, document identifications matching bi-month are obtained. Then, the second document identification is determined from the document identifications matching OKR and bi-month. The document identification library can be a document identification library in the document application background or a third-party document identification library.

It should be noted that the above embodiment exemplarily splits the content in candidate word segmentation, selects the target candidate word segmentation based on the content, and compares the target candidate word segmentation with respective document identification in the document identification library, and obtains the second document identifier with the highest matching degree. in other embodiments, the text box corresponding to the second predetermined position can be split into a plurality of characters, and the characters of the name of respective document title in the document identification library can be selected to repeat the number of characters corresponding to the maximum predetermined number of second document identification, and embodiments of the present disclosure do not limit the specific process of determining the second document identification.

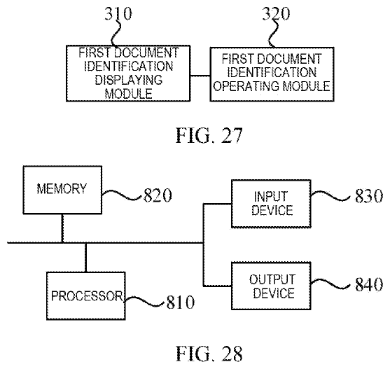

On the basis of the above embodiments, embodiments of the present disclosure further provide a method for document processing, shown in FIG. 27, apparatus for document processing including:
a first document identification displaying module 310 configured to in response to receiving a presenting operation for a document content, display at least one first document identification at a first predetermined position of a content page of a document; and
a first document identification operating module 320 configured to in response to receiving an editing operation at a second predetermined position in the content page, replace or hide the first document identification.

Embodiments of the present disclosure provide an apparatus for document processing, a first document identification displaying module in response to receiving a presenting operation for a document content, display at least one first document identification at a first predetermined position of a content page of a document; and a first document identification operating module in response to receiving an editing operation at a second predetermined position in the content page, replace or hide the first document identification. Based on receiving the presenting operation of the document content, at least one first document identification is displayed to the user in a first predetermined position of the document content page, so the user can directly select the required document template in the first document identification display, in addition, when the user performs editing operation in the second predetermined position of the content page, the first document identification is replaced or hided in the content page of the document, to help the user find a suitable document template more quickly, which optimizes the user's link to the use of the document and simplifies the user operations, and improves user experience.

Optionally, the apparatus further includes:
a first document identification hiding module configured to in response to receiving a content input operation in a first content type region at a second predetermined position in the content page, hiding the first document identification.

Optionally, the apparatus further includes:
a second document identification hiding module configured to in response to receiving a focus location operation in a first content type region at a second predetermined position in the content page, hiding the first document identification.

Optionally, the apparatus further includes:
a content obtaining module configured to in response to receiving a content input operation in a second content type region at a second predetermined position in the content page, obtaining an inputted content;
a replacement module configured to obtain a second document identification based on the content and replacing the first document identification with the second document identification.

Optionally, the apparatus further includes:
a display module configured to hide the first document identification and displaying the second document identification at a corresponding position of the first document identification.

Optionally, the apparatus further includes:
a moving module configured to in response to the second document identification being displayed at the corresponding position, moving the second document identification a first predetermined distance along a first direction and then moving the second document identification a second predetermined distance along a second direction.

Optionally, the apparatus further includes:
a first component display module configured to in response to receiving a presenting operation on a document content, displaying a first component at the first predetermined position;
a hidden module configured to in response to a triggering operation on the first component, hiding a content of the first predetermined position.

Optionally, the apparatus further includes:
a second document display module configured to in response to receiving a presenting operation for a document content, displaying a second component at the first predetermined position;
a document identification interface display module configured to in response to a triggering operation for the second component, displaying a document identification interface, the document identification interface comprising at least one document identification which has an association relationship with the editing operation.

Optionally, the apparatus further includes:
a target document content obtaining module configured to in response to a triggering operation for the first document identification, obtaining a target document content corresponding to the first document identification, displaying the target document content at a content page of the document, and hiding a content of the first document identification and/or the first predetermined position.

Optionally, the apparatus further includes:
a first document page display module configured to in response to a triggering operation for the first document identification, displaying a first document page, the first document page comprising a document content corresponding to the first document identification.

Optionally, the apparatus further includes: a moving predetermined distance module configured to in response to the first document identification being focused on, moving the first document identification a first predetermined distance along a first direction.

Optionally, the apparatus further includes:
a first replacement module configured to if the number of second document identifications obtained based on the content is greater than or equal to a predetermined number, replacing, based on matching degrees, the first document identification with a predetermined number of second document identifications which have the highest matching degrees in the second document identifications.

Optionally, the apparatus further includes:
a second replacement module configured to if the number of second document identifications obtained based on the content is greater than or equal to 1 and less than a predetermined number, replacing the first document identification with the determined second document identification.

Optionally, the apparatus further includes:
a prompt information module configured to if a second document identification is not identified based on the content, displaying prompt information without a second document identification.

Optionally, the apparatus further includes:
a first display unit configured to if the number of obtained second document identifications is greater than a predetermined number, in response to a triggering operation for the second component, displaying a document identification interface, the document identification interface comprising at least one second document identification and at least one second document identification;
or,
a second display unit configured to if the number of obtained second document identifications is less than or equal to a predetermined number, in response to a triggering operation for the second component, displaying a document identification interface, the document identification interface comprising at least one first document identification.

Optionally, the apparatus further includes:
a second document identification display unit configured to obtain the second document identification by performing a fuzzy search in a template library based on the content to, and replacing the first document identification with the second document identification.

The apparatus provided in the embodiment of the present disclosure may perform the method provided in any embodiment of the present disclosure, and has functional modules and beneficial effects corresponding to the execution method.

FIG. 28 is a schematic structural diagram of an electronic device provided by the embodiments of the present disclosure, as shown in FIG. 28, the electronic device includes a processor 810, a memory 820, a input device 830 and output device 840; the number of processor 810 in the electronic device may be one or more, with one processor 810 being used as an example in FIG. 28, the processor 810, memory 820, input device 830 and output device 840 in the electronic device may be connected via a bus or otherwise, with connection via a bus being used as an example in FIG. 28.

The embodiments of the present disclosure also provide a storage medium comprising computer-executable instructions for implementing the method provided in the embodiments of the present invention when executed by a computer processor.

Of course, the storage medium provided by the embodiments of the present invention a comprises computer-executable instructions, which are not limited to the method operations described above, and may also perform relevant operations in the method provided by any embodiment of the present invention.

The present disclosure further provides a computer program product, when running on a computer, causing the computer to execute the method of the application of the foregoing embodiments.

Herein, it should be noted that relational terms such as “first” and “second” are only used to distinguish one entity or operation from another entity or operation, and do not necessarily require or imply any actual relationship or order between these entities or operations. Moreover, the terms “comprises”, “comprising”, or any other variant thereof are intended to cover non-exclusive inclusion, so that a process, method, article, or device that includes a series of elements not only includes those elements, but also includes other elements not explicitly listed, or includes elements inherent to such a process, method, article, or device. Without further limitation, an element defined by the phrase “comprises a . . . ” does not exclude the presence of additional identical elements in the process, method, article, or device that includes the element.

The foregoing is merely a detailed description of the present disclosure to enable those skilled in the art to understand or implement the present disclosure. Various modifications to these embodiments will be apparent to those skilled in the art, and the general principles defined herein may be implemented in other embodiments without departing from the spirit or scope of the present disclosure. Accordingly, the present disclosure will not be limited to the embodiments described herein, but will be subject to the widest scope consistent with the principles and novel features disclosed herein.

1. A method for document processing, comprising:
in response to receiving a presenting operation for a document content, displaying at least one first document identification at a first predetermined position in a content page of a document; and
in response to receiving an editing operation at a second predetermined position in the content page, replacing or hiding the first document identification.

2. The method of claim 1, wherein the in response to receiving an editing operation at a second predetermined position in the content page, replacing or hiding the first document identification comprises:
in response to receiving a content input operation in a first content type region at a second predetermined position in the content page, hiding the first document identification.

3. The method of claim 1, wherein the in response to receiving an editing operation at a second predetermined position in the content page, replacing or hiding the first document identification comprises:
in response to receiving a focus location operation in a first content type region at a second predetermined position in the content page, hiding the first document identification.

4. The method of claim 1, wherein the in response to receiving an editing operation at a second predetermined position in the content page, replacing or hiding the first document identification comprises:
in response to receiving a content input operation in a second content type region at a second predetermined position in the content page, obtaining an inputted content; and
obtaining a second document identification based on the content and replacing the first document identification with the second document identification.

5. The method of claim 4, wherein the replacing the first document identification with the second document identification comprises:
hiding the first document identification and displaying the second document identification at a corresponding position of the first document identification.

6. The method of claim 5, wherein the displaying the second document identification at a corresponding position of the first document identification comprises:
in response to the second document identification being displayed at the corresponding position, moving the second document identification a first predetermined distance along a first direction and then moving the second document identification a second predetermined distance along a second direction.

7. The method of claim 1, further comprising:
in response to receiving a presenting operation on a document content, displaying a first component at the first predetermined position; and
in response to a triggering operation on the first component, hiding a content of the first predetermined position.

8. The method of claim 1, further comprising:
in response to receiving a presenting operation for a document content, displaying a second component at the first predetermined position;
in response to a triggering operation for the second component, displaying a document identification interface, the document identification interface comprising at least one document identification which has an association relationship with the editing operation.

9. The method of claim 1, further comprising:
in response to a triggering operation for the first document identification, obtaining a target document content corresponding to the first document identification, displaying the target document content at a content page of the document, and hiding a content of the first document identification and/or the first predetermined position.

10. The method of claim 1, further comprising:
in response to a triggering operation for the first document identification, displaying a first document page, the first document page comprising a document content corresponding to the first document identification.

11. The method of claim 1, further comprising:
in response to the first document identification being focused on, moving the first document identification a first predetermined distance along a first direction.

12. The method of claim 4, wherein the obtaining a second document identification based on the content and replacing the first document identification with the second document identification comprises:
if the number of second document identifications obtained based on the content is greater than or equal to a predetermined number, replacing, based on matching degrees, the first document identification with a predetermined number of second document identifications which have the highest matching degrees in the second document identifications.

13. The method of claim 4, wherein the obtaining a second document identification based on the content and replacing the first document identification with the second document identification comprises:
if the number of second document identifications obtained based on the content is greater than or equal to 1 and less than a predetermined number, replacing the first document identification with the determined second document identification.

14. The method of claim 4, wherein the obtaining a second document identification based on the content and replacing the first document identification with the second document identification comprises:
if a second document identification is not identified based on the content, displaying prompt information without a second document identification.

15. The method of claim 8, wherein the in response to a triggering operation for the second component, displaying a document identification interface comprises:
if the number of obtained second document identifications is greater than a predetermined number, in response to a triggering operation for the second component, displaying a document identification interface, the document identification interface comprising at least one second document identification and at least one second document identification;
or,
if the number of obtained second document identifications is less than or equal to a predetermined number, in response to a triggering operation for the second component, displaying a document identification interface, the document identification interface comprising at least one first document identification.

16. The method of claim 4, wherein the obtaining a second document identification based on the content and replacing the first document identification with the second document identification comprises:
obtaining the second document identification by performing a fuzzy search in a template library based on the content to, and replacing the first document identification with the second document identification.

17. (canceled)

18. An electronic device comprising:
one or more processors; and
a storage device for storing one or more programs,
the one or more programs, when executed by the one or more processors, causing the one or more processors to implement a method comprising:
in response to receiving a presenting operation for a document content, displaying at least one first document identification at a first predetermined position in a content page of a document; and
in response to receiving an editing operation at a second predetermined position in the content page, replacing or hiding the first document identification.

19. A non-transitory computer-readable storage medium having a computer program stored thereon, the program, when executed by a processor, causing a method comprising:
in response to receiving a presenting operation for a document content, displaying at least one first document identification at a first predetermined position in a content page of a document; and
in response to receiving an editing operation at a second predetermined position in the content page, replacing or hiding the first document identification.

20. The electronic device of claim 18, wherein the in response to receiving an editing operation at a second predetermined position in the content page, replacing or hiding the first document identification comprises:
in response to receiving a content input operation in a first content type region at a second predetermined position in the content page, hiding the first document identification.

21. The electronic device of claim 18, wherein the in response to receiving an editing operation at a second predetermined position in the content page, replacing or hiding the first document identification comprises:
in response to receiving a focus location operation in a first content type region at a second predetermined position in the content page, hiding the first document identification.
